(19) United States
(12) Patent Application Publication
(10) Pub. No.: US 2007/0167178 A1
(43) Pub. Date: Jul. 19, 2007

(54) Short Message Service (SMS) Parser

(76) Inventor: Mansour A. Al-Harbi, Damman (SA)

Correspondence Address: Mr. Walter J. Tencza Jr., Suite 3, 10 Station Place, Metuchen, NJ, 08840, US

(21) Appl. No.: 11/674,394

(22) Filed: Feb. 13, 2007

(30) Foreign Application Priority Data
Jan. 7, 2007 (SA) 07270497

(51) Int. Cl. H04Q 7/20

(52) U.S. Cl. 455/466; 709/206

(57) ABSTRACT

A short message service parser is disclosed. The short message service parser is typically a computer server programmed by computer software. The short message service parser has the ability to handle different short message service messages from different senders and process, analyze, parse, and reformat the messages. The messages are typically reformatted into a format readable for various backend computer systems available on a computer network. The backend computer system processes a request or a transaction and returns a result back to the short message service parser. The short message service parser sends the results back to a sender device, which may be a cellular telephone.

### CROSS REFERENCE TO RELATED APPLICATION(S)

This application claims the priority of Saudi Arabian application serial no. 07270497 filed on Jan. 7, 2007 inventor Mansour A. Al-Harbi

### FIELD OF THE INVENTION

This invention relates to the field of computer software and communications.

### BACKGROUND OF THE INVENTION

With the increasing number of GSM (global systems for mobile communication) networks users, there are needs to extend the functionality of available computer software applications to mobile devices to allow users of these mobile devices to have information in the fastest and easiest way. Transferring information from a mobile device to an existing computer software application and vice versa requires a standard way of communications between the computer software application and the end user mobile device. Preferably, the transmission of this information should be independent of mobile device type, such as cellular telephone type.

To obtain this information in spite of the simplicity of its size in some cases requires using the internet or making a telephone call. One of the disadvantages of using the internet is the availability of the network and devices, such as mobile computers or laptops, and then searching a way to connect to that network either through connectivity devices, such as modems or wireless cards to connect to WiFi (wireless fidelity) network. One disadvantage of the telephone conversation is that the user must wait until a call agent answers the user's call and sometimes the user has to wait for long periods of time when he enters a call queue. The user has to listen to the call agent carefully and respond to a question or request from the call agent. The question or request may require the user to provide an account number and user name, for instance. It is impossible to request any service if the interested user is in a meeting or involved with other duties, especially with a confidential transaction. In addition, the service providers have to employ a number of call agents and other staff to respond to phone users and process user requests.

There are many computer software applications and computer systems that allow a user to get required information or request orders. Examples of these systems are airline flight reservation systems, telephone directory systems, bank systems to transfer money and pay bills, financial broker systems, hospital reservation systems, and others. All of these systems typically have a particular method of input, based on the parameters that a request should contain.

There is in the prior of art a software system that allows a user to send an SMS message containing only one parameter and the software system will process the request. These types of systems are typically linked to only one backend computer system and it is limited to a specific requirement. Typically these prior art software systems can not accept more than one parameter in case the backend system requires that. Also there is other computer software which accepts more than one parameter and it has been used for the stock exchange, but there are many limitations with this type of software. This type of software is one to one system where it (the prior of art software) has to be connected to one and only one backend computer system and it should be implemented by the owner of the desired system. Also, any change in the backend computer system requires changing on the prior of art SMS application. Another dilemma in implementing prior of art SMS application with secured system is the way the password is being send. The previous SMS application requires a user to type the password in the SMS message as well which means the password will be stored in sent item folder of the user mobile device. Another problem with prior of art SMS Application, which accept more than one parameter, is that the SMS message should contains the parameter value in a specific order. For example, the prior of art SMS application which is used by brokers to process transaction in stock exchange system, can accept a number of parameters but the parameters should be ordered in a specific order. If the user disordered the parameters, a prior of art SMS application may proceed with different result than what it is expected. For example, if a user would like to buy a security in the quantity of four hundred fifty four a price four hundred and forty dollars and he by mistake replaced the location of the quantity with the location of the price in the SMS message; his transaction may proceed with an undesired transaction. Another dilemma also, the user has to send very long SMS even for some value which can have default values. Referring to the previous prior of art SMS application used by brokers, the trader has to type the valid period for the transaction however the default value is one day all the time.

U.S. Pat. No. 6,961,330 to Cattan et. discloses a system which is designed for Internet servers only and which does not distinguish between a secure system and a non-secure system. The method disclosed in Cattan uses an HTTP connection to pass a message to a backend computer system. These types of backend systems which are exposed to an HTTP request are not secured since any one can have access to them. These types of systems are usually used to get general information, such as weather and news. Another problem with prior art systems, such as disclosed in Cattan, is that there are no defaults values can be assigned in case some parameters are missing in the message. Another problem with the prior of art mentioned in U.S. Pat. No. 6,961,330 to Cattan, et. is that no optional parameter is assigned. Another problem with Cattan is that the order is important to complete the process. The process disclosed in the Cattan patent will not send the location of the error to the mobile device so he/she will know the exact location of the problem to fix it and send another message.

### SUMMARY OF THE INVENTION

One object of the present invention is to provide the ability for two or more different backend computer system to communicate with one computer software program running on one computer server, which can be called one instance of SMS parser. The two or more different backend computer systems can receives user requests from the one instance of SMS parser (i.e. the SMS parser server). The two or more different backend computer systems may be two different brokerage systems who would like to introduce SMS stock exchange service to their clients but instead of building two different SMS computer software servers or computer software applications running on two computer servers, they will utilize one computer server running one computer software application of SMS parser.

An additional object of the present invention is to provide a preferably universal SMS parser computer server that could work with different backend systems.

A further object of the present invention is to provide the ability to an SMS user to send an SMS message to the SMS parser computer server which will reorder and reorganize the message according to the format required by one of the two or more backend computer systems.

In one embodiment of the present invention, the SMS parser computer server may insert a default value into an optional parameter field of an SMS message to form a modified or reformatted SMS message if the optional parameter field in an original SMS message was missing. One or more embodiments of the present invention provide a system, method, and apparatus that has the ability to receive readable messages from a user, understand the messages, and reformat the messages in a way that can be understood by a desired backend computer system. One embodiment of the present invention provides a short message service (SMS) parser system, which has the ability to receive any SMS (short message service) message and reformat it in a readable message to the desired backend computer system. The SMS Parser system, in one embodiment of the present invention, divides the message into a number of variables and passes them to the intended backend system. The SMS Parser system in accordance with an embodiment of the present invention works as a link between an SMS user or mobile device and any system that accepts one or more than one parameter.

The telephone directory system can be used as an example for a backend computer system. The telephone directory system is available for internet users. They can search for the name of any person or business and find out their contact numbers. Another way to use this telephone directory system is to call the inquiries telephone directory center and provide them the name of the person or institution to return his or her contact numbers. An embodiment of the present invention allows inquiries to the telephone directory center owner to extend their system functionality to an SMS message user by connecting inquiries to the telephone directory center to a central SMS Parser (which may be a universal SMS parser and which is typically shared between many computer systems and/or computer software applications, In this example, among a telephone directory center computer system and/or computer software application and other computer systems and/or software applications like airline flight reservation computer system), typically without the need to implement any SMS computer software application. One or more embodiments of the present invention allow a user, via a mobile device, such as a mobile telephone to communicate with a telephone directory system by using a short message service message (SMS). The user sends an SMS message containing a plurality of variables to do a search with, such as the name of a person and his/her location.

Another example is the stock trading system. Accessing the stock market is typically limited to Internet and GPRS (General Packet Radio Service) users or through a broker or bank. These ways are not sufficient for users since it causes them some heavy time losses when the internet access is unavailable or when a mobile device does not support internet browsing through GPRS. The SMS Parser (an embodiment of the present invention) has the ability to integrate with USSD (Unstructured Supplementary Service Data) Application to request the password from the user in case the system is secure system like a brokerage system.

By this way the password is typically not contained in the message itself. One of the biggest advantages of at least some embodiments of the present invention compared to the prior art is that the order of the parameters is not important. An SMS Parser, in accordance with one or more embodiments of the present invention, can detect that there are some optional fields that are missing values and insert a default value for into the optional fields in the SMS message. One of the novel aspects of one or more embodiments of the present invention is that the provided SMS Parser, which is preferably universal, is not specific to one computer software application or computer software system only. The same instance of SMS Parser of one or more embodiments of the present invention, can work for different flight reservation computer systems, different stock trading computer systems, telephone directory computer systems, hotel reservation computer systems, hospital reservation computer systems and any other computer systems and/or computer software applications. All the mobile devices send their SMS to one and only one telephone number assigned to the SMS Parser and it will redirect it to desired computer system

An SMS parser, which is typically universal, in accordance with an embodiment of the present invention, provides a universal solution that has the ability to accept different SMS messages from different users and/or mobile devices, analyze and process these SMS messages to the desired backend system in an easy and fast way. An embodiment of the present invention provides service provider companies with the capability to extend their system to any SMS mobile user without the need to build any new application. There are typically two types of backend systems:

(a) Public systems: Public systems are systems which are available for the public and can be accessed without any type of authentication. Examples of public systems are the telephone directory system, flight reservation systems for a specific airline, and others (b) Secured systems: Secured systems are systems that are available only for authorized person. Any client would like to access this system, he/she has to register him/her self through his service provider company and the client will receive an access code or password for his transaction. Examples for those systems are a banks and brokers system.

One of the purposes of embodiments of the present invention is to provide the ability to access any system available on the network through very simple ways which is SMS. Any mobile device SMS users will have by this method an easier way than the internet or a phone call to process transaction in any computer system. The mobile user does not have to have a mobile device which supports GPRS or has mobile internet browser. From the other side, any service provider will have the ability to reduce the cost and improve the quality of service he is providing by integrating his current computer system with an SMS parser in accordance with an embodiment of the present invention. A service provider will have the ability to reduce a number of agents or utilize them in better position other than answering calls and processing a transaction.

Here are some of the Universal SMS Parser features:

(a) Universal SMS Parser does not depend on any language (such as English, French, Arabic, etc.) It has the ability to receive a user message and convert it in the language desired by the end system. For example, assume a user sends an Arabic SMS which has a correct and readable format by SMS Parser to access an airline flight reservation system to do a flight booking. Assume further that the flight reservation system accepts English Language only, then the SMS Parser has the ability to convert the SMS into the desired language format that is accepted by the flight reservation System.

(b) SMS Parser is a dynamic application in a way that it could reflect any new changes introduced in the backend system without the need to change the SMS Parser code. For example, if the airline flight reservation system requests a new field (parameter) to be added in the user request, this could be reflected in the SMS Parser without the need to change the programming code. The new field can be integrated in a parameter table.

(c) There are help functions which can be built in the SMS Parser which enable the user to search for any command available and find the system which command send the transaction to it.

(d) The SMS parser may be programmed to have the ability to identify any unknown parameter or word in the SMS and remove it if all requirements are available in SMS message.

(e) If there is any error in the SMS format, or some of the required parameters do not exist, the SMS parser has the ability to identify the location of the error and send it to the user so he can correct the mistake and send it again.

(f) In case connecting to the secured system, the SMS Parser is smart enough to know that the user request is to be sent to a secured system. In this case, SMS Parser will ask from a USSD (Unstructured Supplementary Service Data) Server, which is a dedicated server using USSD technology to communicate with a user through his or her mobile device, to ask the user for the access code of the desired secured system. By this way, the user will not have to enter any password in the SMS message. This will increase the security and credibility for the system and enhance the integrity of the users.

(g) SMS Parser has the ability to fill any optional parameter for the user which he did not mention it in the SMS. Example for that is a bank account number. If the user did not fill it explicitly then SMS Parser may default it to the account number which exists in a user profile. On the other hand, in a case the user would like to do the transaction on another account number; he has to mention it explicitly in the SMS message.

(h) The same instance of SMS Parser has the ability to send SMS transactions to different systems available at the same time. For example, the same SMS Parser application instance has the ability to send SMS transactions to brokers, bank systems, airline flight reservation systems, hospitals for reservations, hotel reservation systems, telephone directory systems and any other system at the same time.

(i) SMS Parser manager is typically the professional who is responsible for SMS Parser system maintenance and upgrades and usually he is the one responsible for server and hardware maintenance as well. He has the ability to write his internal script to deal with any new internal command to be executed within the SMS Parser not by a backend system.

### BRIEF DESCRIPTION OF THE DRAWINGS

FIG. 1 shows a high level diagram for an apparatus using a SMS parser in accordance with an embodiment of the present invention;

FIG. 2 shown a diagram of an apparatus for use with the SMS parser of FIG. 1;

FIG. 3 shows an apparatus for providing data flow for a public system, in this case an airline reservation system, available on a computer network, in accordance with an embodiment of the present invention;

FIG. 4 shows an apparatus for providing data flow for a secured system available on a computer network, in this case a broker system, in accordance with another embodiment of the present invention;

FIG. 5 is a diagram of an image appearing on a screen of a mobile device, which appears when a user of the mobile device tries to access a secure system, such as in FIG. 4;

FIG. 6 is a data flow chart showing a process according to an embodiment of the present invention which will receive an SMS message from a mobile device;

FIG. 7 is a data flow chart showing a process according to an embodiment of the present invention which will parse a user's SMS;

FIG. 8 is a data flow chart showing a process according to an embodiment of the present invention which receives the result for the user mobile device request from a service provider;

FIG. 9 is a data flow chart showing a process according to an embodiment of the present invention which receives user information from a secure system owner to register a specific user on the service;

FIG. 10 is a block diagram which illustrates user interface capability for the SMS Parser Manager;

FIG. 11 is a block diagram which illustrates the connectivity between the SMS Parser and a function executor DLL (Dynamic Link Library).

### DETAILED DESCRIPTION OF THE DRAWINGS

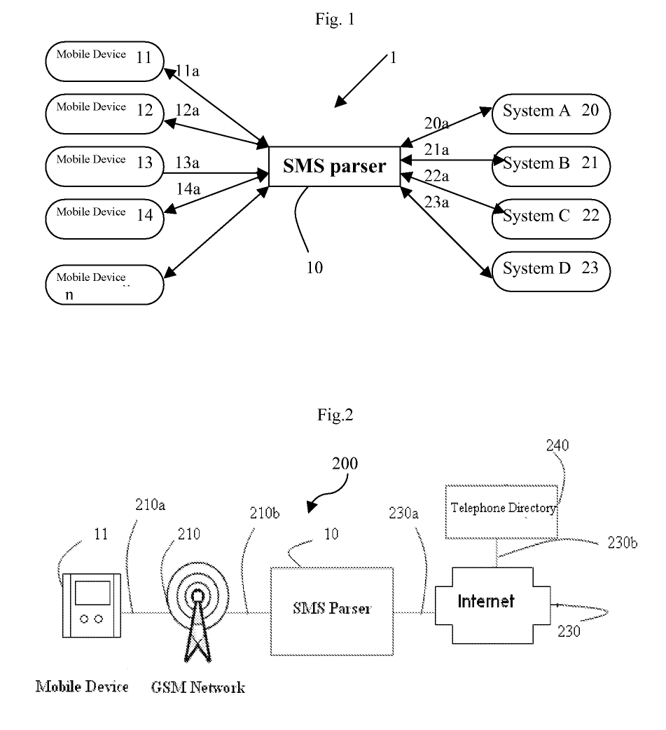

One or more embodiments of the present invention are explained below with reference to the FIGS. 1 to 11.

FIG. 1 shows a diagram of an apparatus 1. The apparatus 1 includes a plurality of mobile devices including mobile devices 11, 12, 13, 14, until mobile device n where n is total number of mobile devices available on a GSM (global system for mobile communication) network. Each of the mobile devices, such as 11-14, may be a mobile telephone or cellular telephone which is operated by a user or a computer server which has the ability to send SMS messages to other computer servers or computer systems.

The apparatus 1 also includes an SMS (short message service) parser 10. The mobile devices 11-14, and n communicate with the SMS parser 10 via communication channels 11a-15a, respectively. The SMS parser 10 may be a computer, such as a computer server. The SMS parser 10 may run a computer program, which may be called an SMS parser computer program.

The SMS parser 10 communicates with system A 20, system B 21, system C 22, and system D 23, via communication channels 20a, 21a, 22a, and 23a, respectively. Each of the systems 20, 21, 22, and 23 may be any type of computer system. For example, each of the systems 20-23 may be an airline flight reservation computer or computer system, a hospital reservation computer or computer system, a financial brokerage computer or computer system, or any other computer, computer network, or computer system.

In one embodiment the SMS parser 10 in FIG. 1, may receive requests from mobile devices 11-14, and n. The requests may be input by individuals operating the mobile devices 11-14, and n. The individuals operating the mobile devices 11-14, and n may include individuals who are using SMS capabilities from their mobile device to communicate with a backend system or systems, such as one of systems 20-23

Each of the mobile devices 11-14, and n may transmit requests via their appropriate communication channel (one of 11a-15a) to the SMS parser 10, for a transaction to be processed or to be logged into one or more of systems 20-23. The systems 20-23 may be available on or accessible via a computer network, such as the internet. The SMS parser 10 transforms a request from one of mobile devices 11-14 and n into a readable format for one or more of the systems 20-23. The SMS parser 10 then transmits via one or more of the communications channels 20a-23a the transformed request to the desired system of systems 20-23.

The SMS parser 10 activities include (1) receiving an SMS request (short message service request) from any device, such as one of mobile devices 11-14, and n, which send SMS requests, (2) reading an SMS request (3) understanding what the SMS request is and sending an error to the appropriate mobile device, such as one of mobile devices 11-14, and n via the appropriate communication channel of channels 11a-15a, if the SMS request contains errors, (4) reformatting the SMS request into readable format for the end system, such as one of systems 20-23, (5) sending the SMS request to the desired system, such as one of systems 20-23, via the appropriate communication channel of communication channels 20a-23a, (6) receiving a result from one of the systems 20-23 via the appropriate communication channel of communications channels 20a-23a and (7) sending the result to one of mobile devices 11-14, n.

FIG. 2 shows a diagram of an apparatus 100 for use with the SMS parser 10. The apparatus 100 includes mobile device 11, GSM (global system for mobile communication) network 210, SMS parser 10, Internet 230, and telephone directory 240. The mobile device 11 communicates with GSM network 210 via communications channel 210a. The GSM network 210 communicates with SMS Parser 10 via communications channel 210b. The SMS Parser 10 communicates with the Internet via communications channel 230a. The Internet 230 communicates with telephone directory 240 via communications channel 230b.

The telephone directory 240 may be a computer server and may be an example of a backend system or backend computer server. The mobile device 11 may be a cellular mobile device. A user of mobile device 11 can send a request to the telephone directory or computer server 240 using the SMS Parser 10. A transaction may be started by a mobile device 11 sending an SMS to the GSM network 210. The SMS may contain a special format for a request to be processed or logged into a system, such as the telephone directory or telephone computer server 240 in FIG. 2. The SMS is transmitted from mobile device 11 to the GSM network 210, via communications channel 210a, then via communications channel 210b to SMS Parser 10 which converts the SMS message into a readable format for the telephone directory system or computer server 240. The SMS Parser 10 then transmits the converted SMS message via communications channel 230a to the Internet or computer network 230. The SMS message is then sent via communications channel 230b to the telephone directory 240.

Preferably the SMS parser 10 is a dedicated computer server, and is comprised of a plurality of CPUs (computer processing units) to enable the SMS parser 10 to perform its operations at high performance, but the SMS parser 10 can be comprised of any computer. The SMS parser 10 is typically divided into two parts. The first part is a user interface, which may be comprised of a computer processor, computer software, computer monitor, keyboard, and/or computer mouse. The user interface may be used by an SMS parser manager, which may be comprised of a human operator and/or a computer software program, to do all the configuration and setting for an SMS parser computer program running on the SMS parser 10. The second part of the SMS parser 10 includes computer software for executing background processes, which run on the SMS parser 10 and which are waiting to receive any messages from the GSM network 210 via communications channel 210b or to receive any messages from the Internet 230 via communications channel 230a to deliver to a mobile device, such as mobile device 11. The SMS parser 10 could be used for applications other than a telephone directory, such as for telephone directory computer server 240, at the same time. For example, the SMS Parser 10 could be used to receive SMS messages from a mobile device, such as 11, which may be sent to a computer server for processing weekly newspaper advertisements (such as catalogs) and the SMS parser 10 may address the selling order into a selling page and so on. The SMS parser 10 also can be used to receive SMS messages from mobile devices, such as 11, and to transmit reformatted SMS messages to computer servers, systems, or networks for airline flight reservations, invoices payment systems, private bank accounts, and to transfer of funds from one account to another.

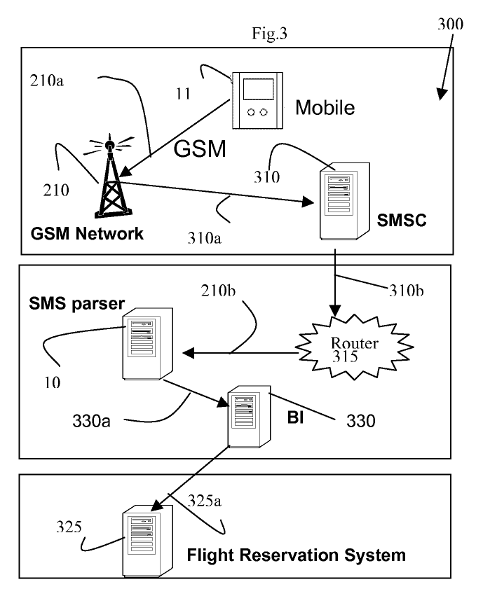

FIG. 3 shows an apparatus 300 for providing data flow for a public system available on a computer network, in accordance with an embodiment of the present invention. The apparatus 300 includes mobile device 11, GSM network 210, SMSC (“short message service center”) 310, SMS parser 10, Business Integrator (BI) 330, router 315, and airline flight reservation system 325. The SMSC 310 may be a computer, server, or computer processor. The airline flight reservation system 325 may be a computer, server, or computer processor. Business Integrator 330 is typically a computer server which provides business process integration between the SMS parser 10 and any backend computer system, such as telephone directory 240 of FIG. 2.

Mobile device 11, which can be any mobile device, such as a mobile cellular telephone, has the ability to send and receive SMS messages. After an SMS message is sent from the mobile device 11 the SMS message goes to GSM Network 210, via communications channel 210a. The GSM Network 210 transmits the SMS message to SMS center 310 via communications channel 310a. The SMSC then forwards the SMS message to SMS Parser 10 via communications channel 310b, router 315 and communications channel 210b. It is preferred to use an SMPP (Short Message Peer to Peer) connection for router 315 between SMSC 310 and SMS Parser 10. This will add more security and integrity of the source of the SMS message but it could work using other connection devices like a GSM modem, either internal or external.

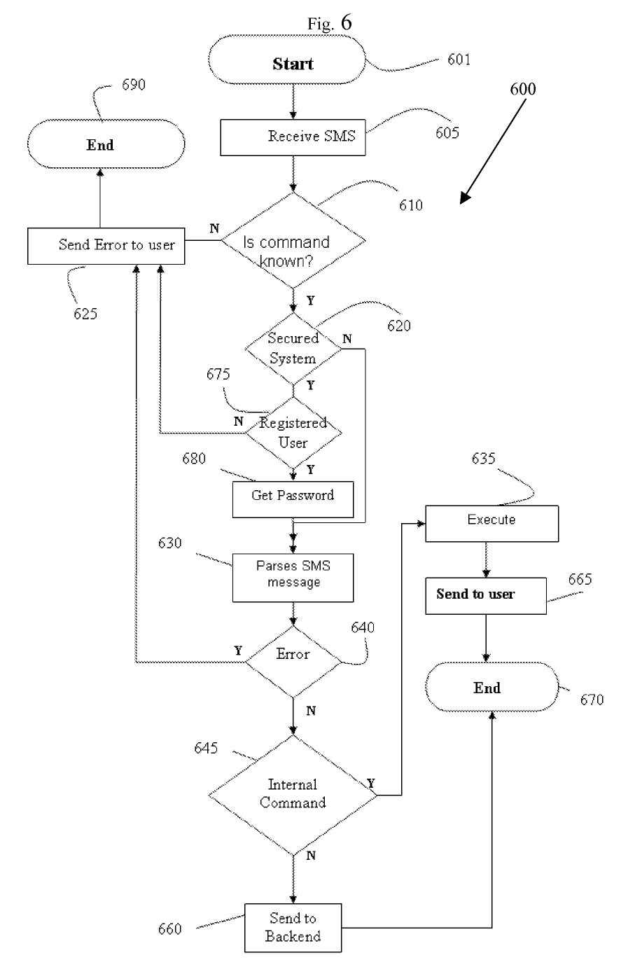

After the SMS parser 10 receives the SMS message, the SMS parser 10 starts many operations as will be described with reference to FIG. 6. The SMS parser 10 sends the request and/or SMS message to the BI server 330 through direct connection 330a which will send the request to a desired backend system, such as the airline flight reservation system or computer server 325 after the SMS parser 10 confirms that the format of the SMS message is accurate. The backend system or in this case airline flight reservation system 325, then processes the request or the transaction and returns a result to the SMS Parser 10 via communications channel 325a and 330a. The SMS Parser 10 then sends the result back to the mobile device 11 using SMS messages.

SMS Parser 10 will typically be connected to the backend system 325 using an off the shelf computer software which provides many different types of connection like web services for instance. There are many third party computer software applications that can provide secure connection to different servers like webMethods™ and Windows BizTalk™. SMS parser 10 could send the request using an SMS message to a backend system via SMS messages if required.

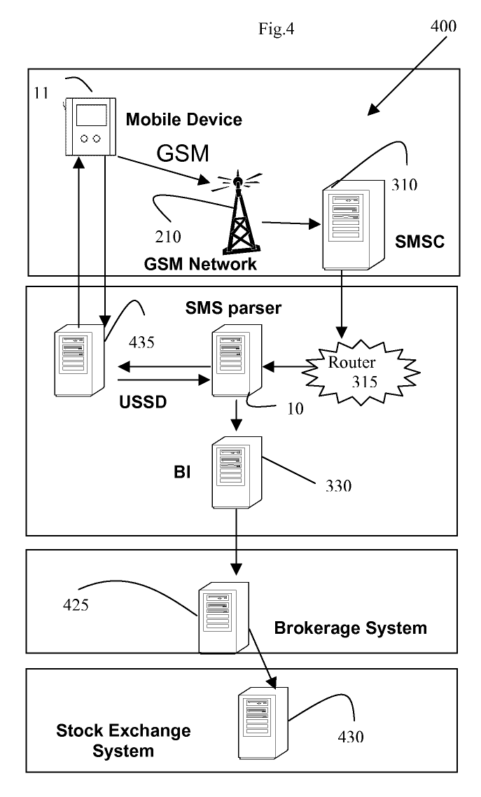

FIG. 4 shows an apparatus 400 for providing data flow for a secured system available on a computer network, in this case a brokerage computer network or system, in accordance with another embodiment of the present invention. The apparatus 400 includes the mobile device 11, the GSM network 210, the SMSC 310, the router 315, the SMS parser 10, a USSD (“Unstructured Supplementary Service Data”) 435, Business Integrator (BI) 330, the brokerage system 425, and a stock exchange system or computer 430. For this type of connection shown by FIG. 4, the backend system (stock exchange system or computer processor 430) has to authenticate a user of the mobile device 11, either by a password or an access code. Since supplying the SMS message with a password is not a secure technique because the password will be stored in a sent item folder, there is a need to utilize another computer server, in FIG. 4 the USSD (Unstructured Supplementary Service Data) computer server 435 which will provide an authentication process. SMS Parser 10 will request from the USSD computer server 435 to pass a USSD message to the mobile device 11 for the user to enter his/her password. The password will be read by USSD Server 435 which then passes it to SMS Parser 10 which then will embed the password in the SMS message and send the SMS message including password to the backend system, in this case stock exchange system or computer server 430.

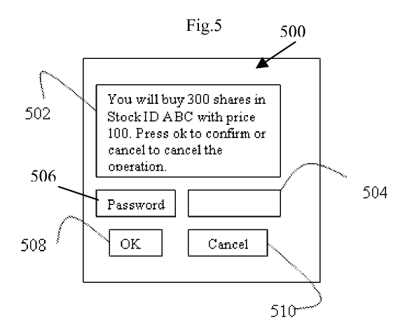

FIG. 5 is a diagram of an image 500 appearing on a screen of a mobile device, such as mobile device 11. The image 500 appears when a user of the mobile device 11 tries to access a secure system or computer server, such stock exchange system 430 of FIG. 4. The image 500 includes fields 502, 504, 506, 508, and 510. The image 500 may appear on a mobile device of a type “i-mate” (trademarked brand name of one a type of mobile telephone) however the usage of the USSD server computer 435 is independent of the type of mobile device. The field 502 indicates that three hundred shares of stock “ABC” are about to be purchased. The image 500 indicates that the OK button or field 508 needs to be pressed to continue with the transaction and the cancel button 510 needs to be pressed to end the transaction. A password has to be entered in field 504 to allow the transaction to take place. Field 506 shows the text of the word “Password”.

FIG. 6 is a data flow chart 600 showing a process according to an embodiment of the present invention which will receive an SMS message from a mobile device, such as mobile device 11. The process shown by data flow chart 600 allows a computer to be a receiver for SMS messages and to format an SMS message in a language understandable by a desired system. The process shown by flow chart 600 is for a computer program which runs on or is incorporated in the SMS parser 10 of FIG. 1-4. The computer program and process starts at step number 601. The process starts as a background process and starts listening to a first port of the SMS parser 10 assigned for receiving SMS messages at step 605. When the SMS parser 10 detects the arrival of any SMS message on the first port, the SMS parser 10 determines if a command in the SMS message is known by using a library or a command table. The library or command table may be stored in computer file system or database of the SMS parser 10. If the SMS message received by the SMS parser 10 starts with an unknown command, then the SMS parser 10 will send an SMS error message at step 625 to the mobile device, such as mobile device 11, of FIGS. 1-4, to tell the user of the mobile device 11, such as by displaying on a computer monitor of the mobile device 11, that the command is unknown. The process would then end at step 690.

If the command of the SMS message received by the SMS parser 10 is a known command at step 610, the SMS Parser 10 will check if the command is meant to be sent to a secured system at step 620. If so, the SMS parser 10 will check if the mobile telephone number of the mobile device 11 or if the account number for the mobile device 11 is registered at step 675. If neither the account number corresponding to the mobile device 11 nor the mobile telephone number corresponding to the mobile device 11 are not registered with this service, the mobile device 11 will receive an error through an SMS message at step 625 before the SMS parser 10 ends the procedure at step 690. If the telephone number for the mobile device 11 or the account number corresponding to the user of the mobile device 11 (which was entered in the SMS message) is registered, then the SMS parser 10 will send a request to the USSD computer server 435 at step 680. The USSD computer server 435 may be running on a computer server or system, typically separate from but it could be running with SMS parser 10 on the same hardware, and adjacent to or in parallel with the SMS parser 10. The request from SMS parser 10 is to get a user password or access code through USSD technology. This is done to make sure no credential information is stored in the user mobile device 11 which will add a greater security feature to the user critical information. If the brokerage system 425 in FIG. 4 is not a secure system, then the two steps mentioned earlier as steps 675 and 680 will be skipped. The SMS message will be parsed at step 630 to get typically all of a plurality of parameters from the SMS message, required for the desired backend system, such as one of backend systems 20-23 of FIG. 1. The parameters will be sorted in the order the backend system, such as one of systems 20-23, requires. If parsing the parameter returning any error at step 640, the error and the error location will be sent to the mobile device, such as mobile device 11, to be corrected in another message at step 625 before it ends at step 690. If there is no error in the SMS message at step 640, the SMS parser 10 will check if the command is an internal command at step 645 like the help command, if it is an internal command then it will be executed internally in the SMS parser 10 at step 635 using a function executor as will be described later with reference to FIG. 11 and the result will be sent to the mobile device 11 at step 665 and the SMS parser 10 will end the program at step 670. If the command is not an internal command, the command will be sent to the backend system or systems such as one or more of systems 20-23 in FIG. 1 to be executed at step 660 and the SMS parser 10 will end the program at step 670.

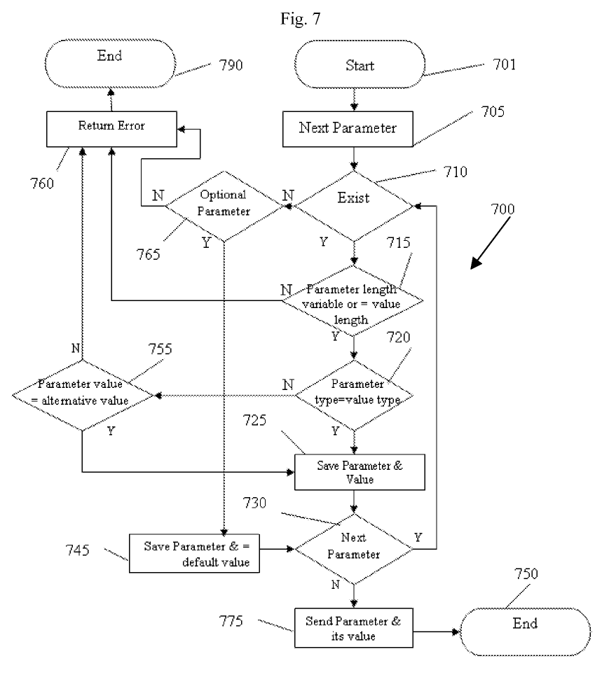

FIG. 7 is a flow chart showing a process which runs on or is incorporated with the SMS parser 10 according to an embodiment of the present invention. The process of FIG. 7 works as an SMS Parser. The SMS parser 10 receives a command and a list of parameters in the SMS message from the mobile device 11. The process starts at step 701. At step 705, the next available parameter from the command of the SMS message is compared versus the library or parameter table, stored in a file system or a database of the SMS parser 10. At step 710, if the parameter does not exist in the library or parameter table the SMS parser 10 will check if the parameter is an optional parameter at step 765. If the parameter is not an optional parameter (meaning that it is a required parameter) then the process running on the SMS parser 10 will return an error at step 760 to the caller process (in this example step 630 shown in FIG. 6). If the parameter is an optional parameter at step 765 of FIG. 7, the SMS parser 10 will save the parameter in its memory and equalize it to a default value stored in the library or in the parameter table in the file system or database of the SMS parser 10 at step 745.

The SMS parser 10 will read the next parameter of the command from the library or parameter table which is stored in a file system or database at step 730. If the next parameter exists in the SMS message at step 710 then the SMS parser 10 will check that a value length for the parameter value is equal to a length value assigned to the parameter in the library or parameter table at step 715 or that the parameter value is shown in the parameter table is a variable length parameter. We can assign number 0 which means that the parameter length is variable and not fixed. If both conditions failed then the SMS parser 10 will return an error at step 760 before the procedure ends at step 790. However if one condition at step 715 is true, then the SMS parser 10 will check if the parameter type assigned for the parameter in the parameter table matches the value type entered by the user into the mobile device, such as 11, at step 720. If the condition is not met, the SMS parser 10 will check if the alternative value assigned for the parameter in the parameter table equals the value inserted by the user at step 755. If not, then the SMS parser 10 will return an error caller process (in this example step 630 shown in FIG. 6) at step 760 before the procedure in FIG. 7 ends at step 790. However if the condition at step 755 or at step 720 is true then the SMS parser 10 will save the parameter to its memory and the value for the parameter at step 725. The SMS parser 10 will start reading the next parameter at step 730. If there are no more parameters for the command from library or parameter table which are stored in file system or database to be read, then the list of the parameters and their values will be returned to the caller process (in this example step 630 shown in FIG. 6) at step 775 and the process will end here at step 750.

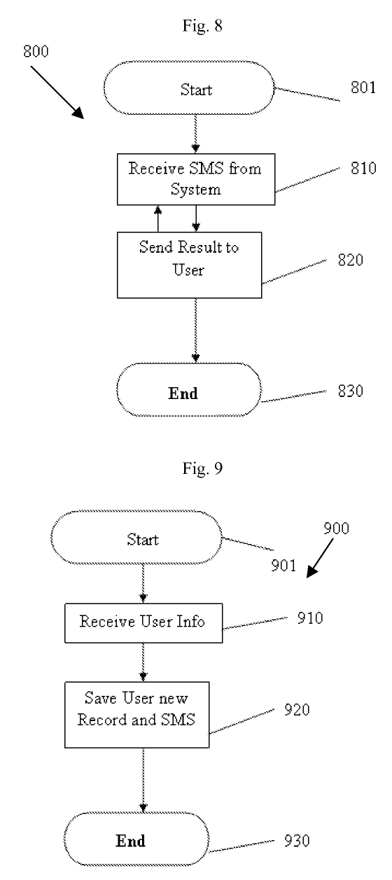

FIG. 8 is a flow chart 800 showing a background process which is part of the computer program for the SMS parser 10 which is waiting for any update coming from the backend systems A, B, C or D 20-23 in FIG. 1. The process shown in FIG. 8, starts at step 801 and this background process monitors a specific port of the SMS parser 10 for any new SMS messages coming from the registered systems A, B, C or D, 20-23 in FIG. 1 at step 810. This process maps the message to the user mobile device 11 from the logging table in a file system or database of the SMS parser 10 and sends the message as an SMS message to the user mobile device 11 at step 820. Then the SMS parser 10 will go back to step 810 until the process is ended by an SMS parser manager.

FIG. 9 shows the flow chart 900 for a process running on or incorporated with the SMS parser 10 which is used to register a user's account or account for a mobile device, such as 11, for a high secured system. This registration comes from a backend system, such as one of systems A, B, C or D 20-23 in FIG. 1. The process of FIG. 9 starts at step 901 by the SMS parser 10 receiving user information and an account number from a backend system such as A, B, C or D 20-23 in FIG. 1 at step 910. For each record, the SMS parser 10 will save the record in a user table or a library in a file system or database on the SMS parser 10 at step 920. It is recommended to do this process during off-peak hours or outside working hours for the SMS parser 10 to ensure high performance for the operation of the SMS parser 10.

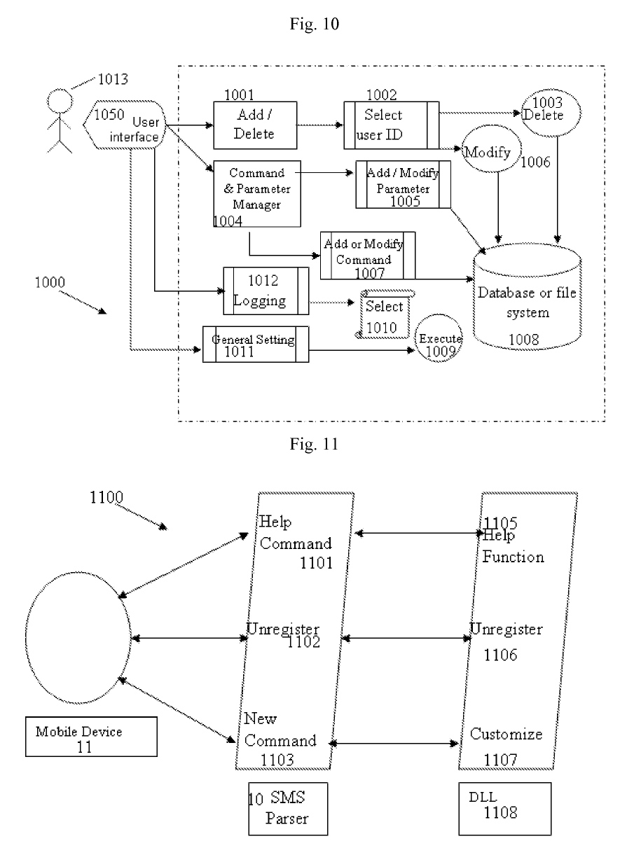

FIG. 10 shows a block diagram 1000 for a user interface 1050 which will enable a person providing input to the SMS parser 10, such as an SMS parser manager 1013 (which may be a person or a computer and/or computer program) to control command syntax and add or modify any existing command and parameter that could be coming as SMS message. The SMS parser manager 1013 can add or delete any registered user mobile device number or account of a user mobile device, such as mobile device 11 at step 1001 by selecting user information at step 1002 and processing it in a library or user information table in a database or file system 1008. SMS parser manager 1013 has the ability to control a command and parameter at step 1004 by adding/modifying any parameter at step 1005 or adding/modifying any command at step 1007 and processing them in the library or the command and parameter table of the SMS parser 10. SMS parser manager 1013 can choose or select at step 1010 the best logging mechanism at step 1012 he is looking for. Typically, there are two types of logging which is “error logging” which shows only the error messages. The second type is “trace logging” which shows every activity in the computer software application. The last option is a general setting at step 1011 where the SMS parser manager 1013 has the ability to do configuration, such as for example modifying the SMPP (Short Message Peer to Peer) connection between the SMS parser 10 and a backend system like telephone directory 240 in FIG. 2 and setting the monitoring port of the SMS parser 10.

FIG. 11 shows the interdependence between the SMS parser 10 computer software and a DLL (Dynamic Link Library) Function Executor 1108, each of which includes computer software running on the SMS parser 10. To give options to the SMS Parser Manager 1013 of FIG. 10, to introduce any fresh feature or appropriate command in the system, SMS Parser Manager 1013 can use the function DLL executor 1108. The SMS parser 10 can be connected to the Dynamic Link Library (DLL) 1108, which enables SMS parser manager 1013 to add any new internal command function to be run within the SMS parser 10. So the SMS parser manager 1013 can do all the customization using the DLL function Executor 1108 computer program. This feature considered as a user exist (user exist is a definition for any function that enables a computer software user to do some modification on the computer according to his/her preferences) once the SMS parser manager 1013 wants to write his own function to execute new internal command. The help command 1101 which is an example of an internal command, for the SMS parser 10, and is connected to DLL 1108 Help function 1105. Also in case a user of the mobile device 11 wants to be unregistered from the SMS Parser system 10, he can use the internal command “unregistered” 1102 which is connected to “unregistered” function 1106 in the DLL Function Executor 1108. Any new internal command can be linked to the customized function 1107 in the DLL Function Executor 1108.

The SMS parser 10 may accept the following format

### Command Parameter(1)[value] parameter(2)[value] parameter(3)[value] . . . Parameter(n)[value]

Wherein the Command is the keyword defined in the file system or database 1008, wherein the Parameter(1) up to the Parameter (n) is defined as a parameter for the Command, and wherein value is the parameter value entered by the user of the mobile device, such as mobile device 11, in the SMS message,
and wherein n is the number of the last parameter. All the commands and the parameters are stored in the command and parameter table or in the library in the database such as database or file system 1008 of FIG. 10, of the SMS parser 10. There typically is a “one to many” relationship between the command table and the parameter table in the SMS parser 10. Here is a table which shows some of the fields which may be needed to complete one embodiment of the present invention:

| | |
|---|---|
| Command | Command that can be used |
| Count | Number of required parameter |
| SharedCommand | Boolean value which indicates if the command is shared with |
| | more than one backend system. In this case the system |
| | connection will be found in one of two tables which are user |
| | tables (for registered users) or the system tables. |
| Language | Language of the command |
| System | The backend system. Here will identify the web-service, SMS |
| | Number, Direct system connection string or remote function call |
| | to send the request to in case Shared Command (mentioned |
| | above in the third row) is false. The parameter contains |
| | parameter name which assigned for the backend system name |
| | in case SharedCommand (mentioned above in the third row) is |
| | true. |
| System_Command | The command that the backend system will accept for this command. |
| Function | The name here will be used to execute the internal function for |
| | the internal command |
| Internal command | Boolean value indicates if it is internal command or external |
| | command to be executed in another system. |
| Help | Provide help about the command |
| Explanation | Contains the syntax of the parameter. |

On the other hand, the parameter table will be as follow:

| | |
|---|---|
| Command | The command linked for such parameter |
| Parameter | Parameter value (One letter only) |
| Parameter Type | “s” means parameter value should be string, “d” means |
| | parameter value should be decimal/or double and “i” means |
| | parameter value should be integer, “t” means parameter value should be |
| | a time or date. |
| Alternative value | The exact Value which will be considered as alternative value for |
| | the parameter value. Example, price in the stock exchange could |
| | be decimal or “m” which means market price. So if SMS parser |
| | manager inserted here “m” as an alternative value for the “p” |
| | (price parameter which its value should be type “d” decimal), |
| | whenever the value inserted by the user for the price parameter |
| | “p” not a type of decimal, SMS parser will check if parameter |
| | value is equal letter “m” (which means market price in this |
| | example) other wise it will flag an error. |
| System parameter | The parameter that will be accepted by the backend system |
| Order | The order of the parameter that is accepted by the backend system |
| Length | Length of parameter value. Number 0 indicates that the |
| | parameter accept variable length value |
| Optional | Boolean value to reflect if the parameter is optional or required |
| Default | Default value of the parameter incase if it is optional. It could be |
| | direct value, SQL statement or a value from previous required |
| | parameter entered by the user in the SMS message. |
| Help | Help about the parameter. |
| Explanation | Syntax of the parameter |

### Let us take an example of a telephone directory system, such as 240 of FIG. 2.

### A telephone directory web service may accept the following format.

First Name, Last Name, Location

Where first name and location is a must (required parameter), which means the user has to supply them and last name is an optional and the default value for the last name is ‘*’ which indicates any last name. The system may then perform a search.

The command syntax to communicate with a telephone directory, such as 240 of FIG. 2, may be as follows:

Directory 1 (First name) 2(Last name) L(Location)

So the user can send an SMS from his mobile device, such as mobile device 11, with the following content:

Directory 1Mansour 2Harbi LKSA

SMS Parser 10 has the ability to understand the statement and send it to the telephone directory 240 in FIG. 2 using the following format:

Mansour, Harbi, KSA

Imagine the user mobile device 11 sends:

Directory LKSA 2Harbi 1Mansour

It will work fine and the SMS Parser 10 will send to the telephone directory 240 in FIG. 2.

Mansour, Harbi, KSA

If the user mobile device 11 sends to the SMS Parser 10 the following:

Directory 1Mansour LKSA

SMS Parser computer 10 will process his request and send to the telephone directory 240 in FIG. 2 the following:

### Mansour,*, KSA

If the user sends to SMS Parser 10 the following:

Directory 1Mansour 2Harbi

Then the SMS Parser computer 10 will return to the user mobile device 11 an error directly saying the location parameter is a must to perform a search.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. An apparatus comprising:
a computer;
wherein the computer is programmed by a computer software application;
wherein the computer software application has the ability to link a short message service (SMS) sender with a first backend computer system available on a computer network using SMS technology;
wherein the computer receives a first SMS message from the SMS sender;
wherein the first SMS message includes a command and a list of parameters having a plurality of corresponding values;
wherein the computer is programmed by the computer software application to parse, analyze, and reformat the first SMS message according to the requirements of the first backend computer system.

2. The apparatus of claim 1
wherein the SMS sender is a mobile device.

3. The apparatus of claim 1
wherein the SMS sender is a computer system that has the ability to send SMS messages.

4. The apparatus of claim 1 wherein
the computer is programmed by the computer software application to receive the first SMS message in a first natural language and transmit it to the first backend computer system in a second natural language

5. The apparatus of claim 1 wherein
the computer is programmed by the computer software application to receive the command and the parameters of the first SMS message in a first order and to reorder the parameters in the first SMS message in a second order to form a modified first SMS message and to transmit the modified first SMS message to the first backend computer system wherein the first order is unknown to the first backend computer system.

6. The apparatus of claim 1 wherein
the computer is programmed by the computer software application to recognize whether the first backend computer system is a public system and if the first backend computer system is a public system, to send the modified SMS message to the first backend computer system.

7. The apparatus of claim 1 wherein
the computer is programmed by the computer software application to recognize that the first backend computer system is a secured system and to send a request to the SMS sender to have a user type an access code into the SMS sender to access the first backend computer system.

8. The apparatus of claim 1 wherein
the computer is programmed by the computer software application to divide the first SMS message into a command and a plurality of parameters, each of which has a corresponding value;
wherein the command is selected from the group consisting essentially of one of the following command types:
(a) an external command dedicated to only the first backend computer system;
(b) an external command shared between two or more backend computer systems; and
(c) an internal command not linked to any backend computer system.

9. The apparatus of claim 8 wherein
the parameter is selected from the group consisting essentially of one of the following:
(a) a required parameter as defined by the first backend computer system; and
(b) an optional parameter as defined by the first backend computer system.

10. The apparatus of claim 8 wherein
each of the corresponding values have a length selected from the group consisting essentially of one of the following:
(a) a fixed length as defined by the first backend computer system; and
(b) a variable length as defined by the first backend computer system.

11. The apparatus of claim 8 wherein
each of the corresponding values have a type selected from the group consisting essentially of one of the following
(a) a string as defined by the first backend computer system;
(b) an integer as defined by the first backend computer system;
(c) a decimal as defined by the first backend computer system;
(d) a date as defined by the first backend computer system;
(e) an alternative direct value as defined by the first backend computer system; and
(f) a list of an alternative direct values as defined by the first backend computer system.

12. The apparatus of claim 1 wherein
the computer is programmed by the computer software application to return an error message to the SMS sender in any case selected from the group consisting essentially one of the following:
(a) if the command in the first SMS message is unknown;
(b) if a first parameter is not included in the first SMS message when required by the first backend computer system;
(c) if a value type in the first SMS message does not match a value type assigned by the first backend computer system to the same parameter;
(d) if a value length in the first SMS message does not match a value length assigned by the first backend computer system and the value length assigned by the first backend computer system is not a variable length; and
(e) if the SMS sender user is not registered with the first backend computer system;
and wherein the first backend computer system is a secured system.

13. The apparatus of claim 1 wherein
the computer is programmed by the computer software application to provide a default value for a first parameter to be sent to the first backend computer system if the first parameter is an optional parameter as specified by the first backend computer system and a value for the first parameter is not included in the first SMS message.

14. A method comprising
linking a short message service (SMS) sender with a first backend computer system available on a computer network using short message service technology;
receiving a command and a plurality of parameters having a plurality of corresponding values in a first SMS message from the SMS sender; and
parsing, analyzing, and reformatting the first SMS message according to a first set of criteria.

15. The method of claim 14
wherein the SMS sender is a mobile device.

16. The method of claim 14
wherein the SMS sender is a computer system that has the ability to send SMS messages.

17. The method of claim 14 further comprising
receiving the first SMS message in a first natural language and transmitting it to the first backend computer system in a second natural language.

18. The method of claim 14 further comprising
wherein the plurality of parameters are in a first order;
reordering the list of parameters in a second order to form a modified first SMS message;
wherein the second order is specified by the first backend computer system;
further comprising transmitting the modified SMS message comprised of the plurality of parameters and values in the second order to the first backend computer system;
and wherein the first order is unknown to the backend computer system

19. The method of claim 14 further comprising
determining that the first backend computer system is a public backend computer system; and
sending the modified first SMS message directly to the first backend computer system.

20. The method of claim 14 further comprising
determining that the first backend computer system is a secured backend computer system; and
sending a request to the SMS sender to have a user to type an access code into the SMS sender to access the first backend computer system.

21. The method of claim 14 further comprising
dividing the first SMS message into a command and a plurality of parameters, each parameter having an assigned value;
wherein the command is selected from the group consisting essentially of one of the following:
(a) an external command dedicated to only the first backend computer system
(b) an external command shared among two or more backend computer systems; and
(c) an internal command not linked to any backend computer system.

22. The method of claim 21 further comprising wherein
each of the plurality of parameters is selected from the group consisting essentially of one of the following:
(a) a required parameter that must exist in the SMS message as defined by the first backend computer system; and
(b) an optional parameter as defined by the first backend computer system.

23. The method of claim 21 further comprising and wherein
a value length of each of the plurality of parameters is selected from the group consisting essentially of one of the following:
(a) a fixed length as defined by the first backend computer system; and
(b) a variable length as defined by the first backend computer system.

24. The method of claim 21 further comprising wherein
each of the values have a type selected from the group consisting essentially of one of the following
(a) a string as defined by the first backend computer system;
(b) an integer as defined by the first backend computer system;
(c) a decimal as defined by the first backend computer system;
(d) a date as defined by the first backend computer system;
(e) an alternative direct value as defined by the first backend computer system; and
(f) a list of alternative direct value as defined by the first backend computer system

25. The method of claim 14 further comprising
returning an error message to the SMS sender in a case selected from the group consisting essentially of one of the following:
(a) if a command does not exist in the first SMS message;
(b) if a parameter required by the first backend computer system is not included in the first SMS message;
(c) if a value type in the first SMS message does not match a value type assigned by the first backend computer system for the same parameter;
(d) if a value length coming in the first SMS message does not match the value length assigned by the first backend computer system and the value length assigned by the first backend computer system is not variable length; and
(e) if an SMS sender user requesting access to a secured backend computer system is not registered with the secured backend computer system.

26. The method of claim 14 further comprising
providing a default value for a first parameter to be sent to the first backend computer system if the first parameter is an optional parameter as specified by the first backend computer system and a value for the first parameter is not included in the first SMS message.
